(19) United States
(12) Patent Application Publication
(10) Pub. No.: US 2002/0179862 A1
(43) Pub. Date: Dec. 5, 2002

(54) Variable laser aperture using a flex circuit

(75) Inventors: Bryan L. Olmstead, Eugene, OR (US); Joseph G. Mistkawi, Eugene, OR (US)

Correspondence Address: LYON & LYON LLP, 633 WEST FIFTH STREET, SUITE 4700, LOS ANGELES, CA, 90071, US

(73) Assignee: PSC Scanning, Inc.

(21) Appl. No.: 09/872,350

(22) Filed: Jun. 1, 2001

(51) Int. Cl. G06K 5/00; G06K 11/00

(52) U.S. Cl. 250/556

(57) ABSTRACT

A system for and a method of optical scanning which provide for focusing a light beam using one or more flex circuits, each flex circuit containing an aperture that is moved into or out of the outgoing optical path of a light beam via an electromagnetic mechanism. The electromagnetic mechanism includes a moving coil or moving magnet attached to each flex circuit for positioning the flex circuit aperture in or out of the outgoing optical path when the electromagnetic mechanism is actuated by an electric current. By positioning a greater or lesser number of apertures in the outgoing optical path, the final aperture size may be modified, thereby adjusting the focal location and depth of field of the light beam. Accordingly, the scanning system provides improved focusing characteristics, as well as an increased read range.

### BACKGROUND OF THE INVENTION

The field of the present invention relates to data reading systems. In particular, an optical scanning system and method for focusing a light beam using one or more flex circuits, each containing an aperture, are described herein.

Optical scanning systems utilize outgoing light beams to read symbols, such as bar codes. In a typical scanning system, a light beam is generated from a light source, such as a laser diode, and is directed toward a bar code for reading the bar code. The light beam may be directed off of one or more pattern mirrors before it reaches the bar code. Furthermore, a scanning mechanism, such as a dithering mirror or a rotating polygon mirror, may be used to scan the light beam across the surface of the bar code. Once the light beam reaches the bar code, return light is reflected from the bar code and collected by a collection system. The collection system focuses the return light onto a photodetector, which converts the signal from the return light into an electrical signal that is sent to a processing system for processing.

Several optical scanning systems are known in the art that utilize optical components such as converging lenses to focus a light beam generated from a laser diode. The focused light beam light beam generated from a laser diode. The focused light beam is then directed toward a bar code for scanning. Many of these systems also utilize one or more apertures to further focus the light beam and to increase the depth of field over which the light beam can read the bar code. The apertures employed in many of these systems modify light beams in the same manner each time that they encounter a light beam. Accordingly, the light beams are focused to the same location with the same depth of field each time that a light beam is generated. As a result, the read range of such scanning systems is relatively limited.

Various improvements have been made to scanning systems employing apertures that provide more flexibility than traditional scanning systems. For example, an electronically actuable variable aperture system is disclosed in U.S. Pat. No. 5,945,670 (the '670 patent) that increases the depth of field of a scanning system. The variable aperture system of the '670 patent utilizes moving panel systems or liquid crystal devices that are selectively activated to increase or decrease the final aperture size, thus modifying the focal location and depth of field of the scanning system. Each of these systems has its limitations. Thus, it is desirable to have alternate designs for a variable aperture system that require minimal power to rapidly switch apertures into and out of a beam path with minimal optical distortion, thereby meeting specific focal requirements and increasing the read range of the scanning system.

### SUMMARY OF THE INVENTION

The present invention is directed to a system for and a method of optical scanning which provide for focusing a light beam using one or more flex circuits, each containing an aperture. In a preferred configuration, each flex circuit aperture is selectively positionable in and out of the outgoing optical path of the light beam via an electromagnetic field. By positioning a greater or lesser number of apertures in the outgoing optical path, the final aperture size is modified, which in turn adjusts the focal location and/or depth of field of the light beam. The electromagnetic actuation of the flex circuits provides for a low power, low voltage, rapid switching of apertures into and out of the outgoing optical path of the light beam with minimal optical distortion.

### BRIEF DESCRIPTION OF THE DRAWINGS

FIG. 1 is a schematic diagram illustrating a scanning system utilizing flex circuits having apertures according to a first preferred embodiment;

FIG. 2a is a side sectional view of an aperture system illustrating how an aperture modifies the depth of field of a light beam;

FIG. 2b is a side sectional view of an aperture system illustrating how an aperture modifies the focal location of a light beam;

FIG. 3 is a graph illustrating how the depth of field of a light beam is affected by the size of an aperture;

FIG. 4 is a bottom plan view of a flex circuit having an aperture according to a preferred embodiment;

FIG. 5a is a side sectional view of a flex circuit having an aperture according to an alternative embodiment;

FIG. 5b is a top plan view of the flex circuit of FIG. 5a;

FIG. 6a is a side sectional view of a dual flex circuit assembly;

FIG. 6b is a close up side sectional view of the dual flex circuit assembly of FIG. 6a;

FIG. 7 is a perspective view of the dual flex circuit assembly of FIG. 6; FIG. 8 is an exploded view of the dual flex circuit assembly of FIGS. 6-7.

### DETAILED DESCRIPTION OF THE PREFERRED EMBODIMENTS

Preferred embodiments will now be described with reference to the drawings. To facilitate description, any reference numeral representing an element in one figure will represent the same element in any other figure.

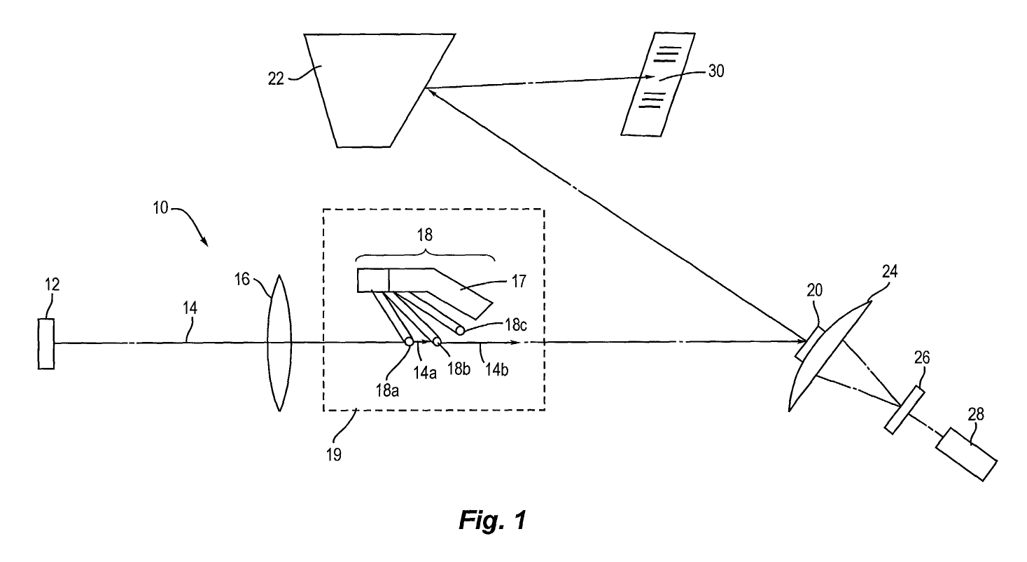

FIG. 1 is a schematic diagram of a scanning system 10 according to a first preferred embodiment. A light source 12, such as a laser diode or other suitable light emitter, generates a light beam 14 along an outgoing optical path toward a target, shown in this example as a bar code 30. The target may be any object desired to be read including bar codes, industrial symbols, alphanumeric characters, other indicia for object recognition, or some other object. To simplify description, the bar code example will be employed in the following examples.

The light beam 14 is focused by a focusing lens 16 and directed toward the bar code 30. At least one flex circuit is disposed in the outgoing optical path downstream from the focusing lens 16. A flex circuit system 18 comprising three flex circuits, 18a, 18b, and 18c is shown in FIG. 1 by way of example only. The flex circuits 18a, 18b, 18c may be combined in a module 19 or installed separately. A greater or lesser number of flex circuits may be utilized depending on the specific focal requirements of the given scanning application. Each flex circuit has two ends, a first end fixedly attached to a housing 17 or other mount, and a second movable end allowing the flex circuit to operate as a cantilever beam. The second movable end includes an aperture for focusing the light beam 14 when it passes through the aperture. The aperture may be circular, oval, slot shaped (i.e., aperturing the beam in only one axial direction, usually the scanning direction), or any other shape that facilitates focusing the light beam 14. Additionally, the edges of the aperture may be jagged as described in U.S. Pat. No. 5,945,670 (the '670 patent) hereby incorporated by reference. The aperture may also be non-symmetric or offset so that it blocks one side of the beam more than the other, as is also described in the '670 patent. The apertures in the flex circuits 18a, 18b, 18c can be individually moved into and out of the outgoing optical path in a rapid manner via an electromagnetic field generated by an electromagnetic mechanism. The electromagnetic mechanism preferably comprises a magnet and a coil actuated by an electric current for moving the apertures of the flex circuits into and out of the outgoing optical path, as further described below.

In FIG. 1, the flex circuit system 18 is engaged by the electromagnetic mechanism to position the apertures of two flex circuits 18a, 18b in the outgoing optical path, while the aperture in flex circuit 18c is positioned out of the outgoing optical path. Thus, only the apertures in flex circuits 18a, 18b contribute to focusing the light beam 14 in the flex circuit system 18 position illustrated in FIG. 1. When the light beam 14 reaches the flex circuit 18a, the flex circuit 18a blocks the light beam 14 except for a portion of the light beam 14 that is focused by the aperture, shown as light beam 14a. Thus, the flex circuit 18a, as well as each successive flex circuit, is preferably constructed from a sufficiently diffusive or opaque material, such as plastic or a polymeric resinous material, to block the portion of the light beam 14 that does not pass through the aperture.

Alternatively, the flex circuits 18a, 18b, 18c may be constructed from a material having grey-scaling characteristics, as described in the '670 patent, to adjust the focal location of the light beam 14. However, it is preferred that the apertures in the flex circuits are used to focus the light beams as opposed to the flex circuit material itself focusing the light beams via grey-scaling.

After the light beam 14a passes through the aperture in flex circuit 18a, it is directed toward the flex circuit 18b. The flex circuit 18b has a smaller or narrower aperture than the flex circuit 18a for further focusing the light beam 14a. Flex circuit 18b blocks the light beam 14a except for a portion of the light beam 14a that is focused by the aperture, shown as light beam 14b.

The light beam 14b bypasses the flex circuit 18c because the aperture of flex circuit 18c is positioned out of the outgoing optical path by the electromagnetic mechanism. Accordingly, the flex circuit 18c does not contribute to focusing the light beam 14b. The focused light beam 14b is then directed toward the bar code 30.

In FIG. 1, the light beam 14b is reflected off of a fold mirror 20 toward a scanning assembly, shown in this example as a rotating polygon mirror 22. The scanning assembly may comprise any suitable scanning mechanism, such as an oscillating mirror pivoted over a scan angle or a dithering mirror assembly. The rotating polygon mirror 22 is shown by way of example only. Alternatively, the light beam 14b may be directed from the aperture 18b toward the bar code 30 without the use of a fold mirror and/or a scanning assembly. Configurations utilizing various other scanning components may also be employed in the scanning system 10 without departing from its variable aperture focusing objective.

Still referring to FIG. 1, the rotating polygon mirror 22 scans the light beam 14b over a scan angle either directly toward the bar code 30, or the beam 14b may be scanned across one or a plurality of pattern mirrors which in turn direct multiple scan lines into a scan volume. In this embodiment, as the light beam 14b scans across the bar code 30, it is reflected back along an incoming optical path generally parallel to its outgoing optical path. Return light from the bar code 30 is collected by a collection element 24, such as a lens, collection mirror, or other optical collector, and directed or focused onto a photodetector 26. The photodetector 26 converts the return signal impinging thereon into an electrical signal that is sent to a processing system 28. The processing system 28 generally converts the electrical signal into a digital pulse signal in which the widths and spacings between the pulses correspond to the widths of the bars and the spacings between the bars of the bar code 30. A decoder, typically a microprocessor, then decodes the pulse signal to obtain the bar code information.

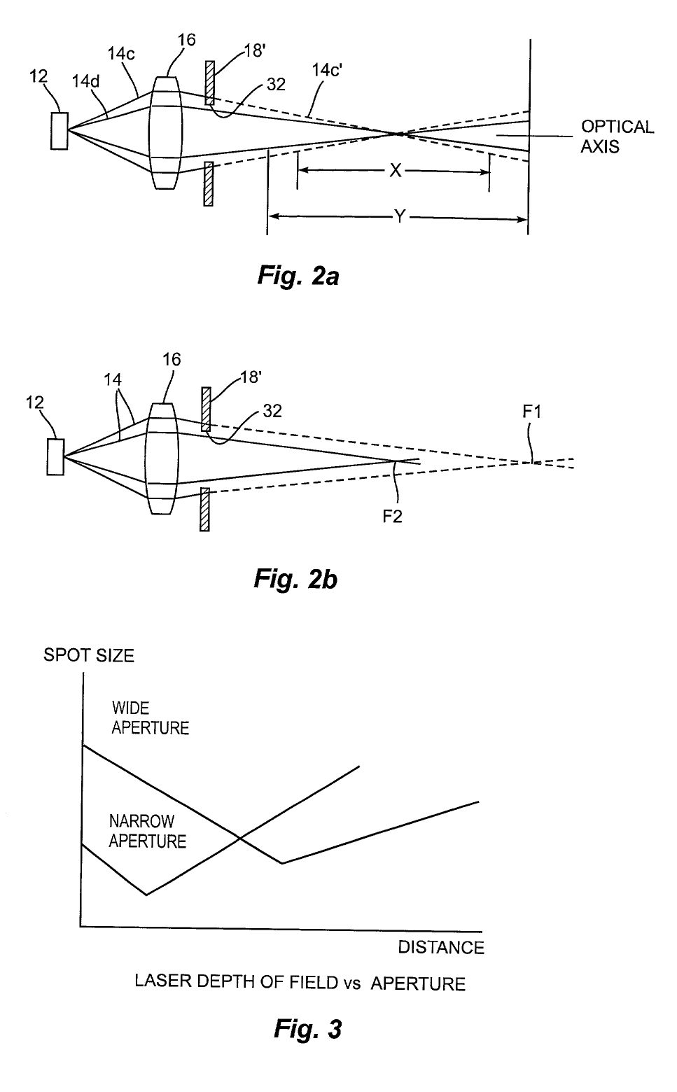

FIG. 2a illustrates the effect that an aperture 32 has on the depth of field of a light beam 14. The aperture 32 must be smaller than the diffractive limit of the light beam 14 so that the aperture 32 impinges on the light beam 14 enough to affect the beam propagation in accordance with diffraction theory. The widely diverging portion of the light beam 14, shown as ray 14c, is blocked by a flex circuit 18′. Optical path 14c′, shown in dashed lines, illustrates how ray 14c would travel if it were not blocked by the flex circuit 18′. A less divergent portion of the light beam 14, shown as ray 14d, passes through the aperture 32 unimpeded. If the flex circuit 18′ with aperture 32 were not employed, the useful read range of the scanning system 10, where the beam size is small enough to read a bar code, would be that indicated by range X. By using the aperture 32 to focus the light beam 14, the useful read range of the scanning system is relatively longer, as indicated by range Y. Accordingly, the use of one or more apertures can increase the depth of field of a scanning system.

FIG. 2b illustrates that aperture 32 can further be used to adjust the focal location of the light beam 14. Focal location F1 indicates where the light beam 14 would be focused if it were not blocked by the flex circuit 18′. Focal location F2, on the other hand, indicates one possible location where the light beam 14 could be focused using the aperture 32. Focal location F2 is shown by way of example only. The aperture 32 may be sized in such a manner that it focuses the light beam 14 to any of several locations to meet the specific focal requirements of a scanning system. The smaller or narrower the aperture 32, the closer the focal location will occur to the aperture 32, as further described below.

Moreover, more than one aperture may be utilized to adjust the focal location of the light beam 14. For example, the flex circuit system 18 of FIG. 1 utilizes three flex circuits 18a, 18b, 18c, each of which may be placed into the outgoing optical path of the light beam 14. Flex circuit 18b has a smaller or narrower aperture than flex circuit 18a, and flex circuit 18c has a smaller or narrower aperture than flex circuit 18b. Thus, as more apertures are placed into the outgoing optical path, the final aperture size becomes smaller or narrower and the focal location of the light beam 14 moves closer to the aperture system 18.

FIG. 3 is a graph illustrating how the focused spot size of a light beam is effected by an aperture. A narrow aperture produces a small focused spot that occurs close to the aperture, as illustrated by plot line 5. A wider aperture, conversely, produces a larger focused spot that occurs farther from the aperture, as illustrated by plot line 15. Thus, by changing the aperture size, the spot size characteristics of a light beam can be modified, providing an “auto-focus” type laser beam system.

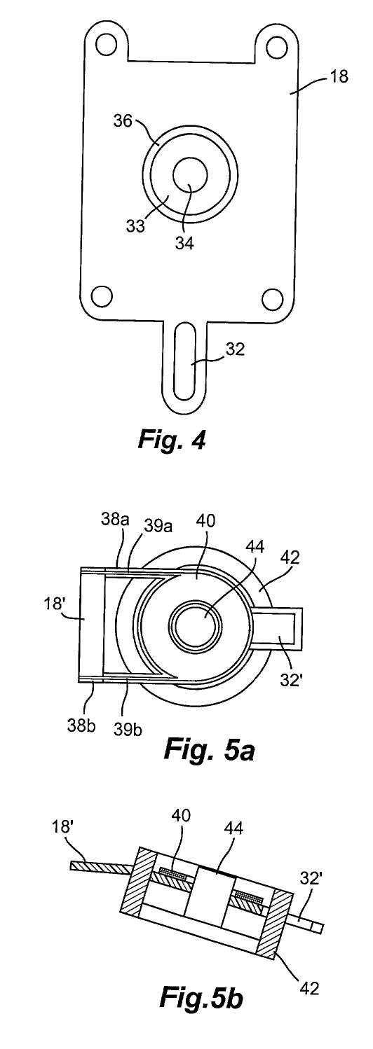

FIG. 4 illustrates a bottom plan view of a preferred embodiment of a flex circuit 18 with an aperture 32 located at one end and an electromagnetic mechanism located at its center. The electromagnetic mechanism comprises a steel keeper 33, a movable magnet 34, and a drive coil 36. The steel keeper 33 is mounted on the flex circuit 18 and includes a circular depression in its center. The movable magnet 34 is mounted in the circular depression of the steel keeper 33. The movable magnet 34 and the steel keeper 33 are proximate the drive coil 36, which is fixed to a housing or other suitable mount. When the drive coil 36 is actuated by electric current, the movable magnet 34 is attracted to or repelled by the drive coil 36, depending on the polarity of the electric current. When the magnet 34 moves due to the electric current, the end of the flex circuit 18 including the aperture 32 also moves. When the drive coil 36 is actuated by an electric current having a polarity that attracts the movable magnet 34, the magnet 34 moves toward the drive coil 36 and the aperture 32 is placed into the outgoing optical path of a light beam. Conversely, when the drive coil 36 is actuated by an electric current having the reverse polarity, the magnet 34 is repelled by the drive coil 36 and it moves away from the drive coil 36, thereby moving the aperture 32 out of the outgoing optical path. The same process may occur with multiple flex circuits, each having a magnet 34 proximate a drive coil 36. Alternatively, the drive coil 36 and the movable magnet 34 may be configured so that the magnet 34 moves out of the outgoing optical path when it is attracted to the drive coil 36, and into the outgoing optical path when it is repelled by the drive coil 36. By rapidly moving apertures into and out of the outgoing optical path, the focal location and depth of field of a light beam can be altered, as described above.

FIGS. 5a and 5b illustrate an alternative embodiment of a flex circuit 18′ with an aperture 32′ located at one end and an alternative electromagnetic mechanism located at its center. The flex circuit 18′ includes two narrow cantilever beam arms 38a, 38b, each carrying a conductive trace 39a, 39b connected to a movable coil 40 attached to a central region of the flex circuit 18′. Electric current is delivered to the movable coil 40 via the conductive traces 39a, 39b. The movable coil 40 can be a free form coil soldered to the flex circuit 18′, or a trace coil constructed from the traces themselves. The movable coil 40 is proximate a ring magnet 42 that is fixed to a housing or other suitable mount. The ring magnet 42 surrounds a steel keeper 44 located at its center. When electric current is sent to the movable coil 40, the ring magnet 42/keeper 44 assembly creates a radial magnetic field that attracts or repels the movable coil 40, depending on the polarity of the electric current running through the coil 40. When the coil 40 moves due to the electric current, the end of the flex circuit 18′ including the aperture 32′ also moves. When the movable coil 40 is actuated by an electric current having a polarity that attracts it to the ring magnet 42, the coil 40 moves toward the ring magnet 42 and the aperture 32 is placed into the outgoing optical path of a light beam. Conversely, when the movable coil 40 is actuated by an electric current having the reverse polarity, the coil 40 is repelled by the ring magnet 42 and the coil 40 moves away from the ring magnet 42, thereby moving the aperture 32 out of the outgoing optical path. Alternatively, the movable coil 40 and the ring magnet 42 may be configured so that the coil 40 moves out of the outgoing optical path when it is attracted to the ring magnet 42, and into the outgoing optical path when it is repelled by the ring magnet 42.

When the flex circuit configuration illustrated in FIGS. 5a and 5b is utilized, multiple flex circuits may be stacked in the same magnetic field because the forces of the coils upon one another are negligible. Thus, multiple apertures can be generated using a single ring magnet 42. Each coil is individually actuated so that some apertures can be moved into the outgoing optical path, while others are moved out of the outgoing optical path. Because the conductive traces 39a, 39b are located in a bend portion of the cantilever beam arms 38a, 38b, the flex circuit 18′ is stiffer per cross sectional area than the moving magnet flex circuit 18 of FIG. 3. Accordingly, the cantilever beam arms 38a, 38b should be very narrow. By moving various apertures into and out of the outgoing optical path with a single ring magnet 42, the focal location and depth of field of a light beam can be altered, as described above.

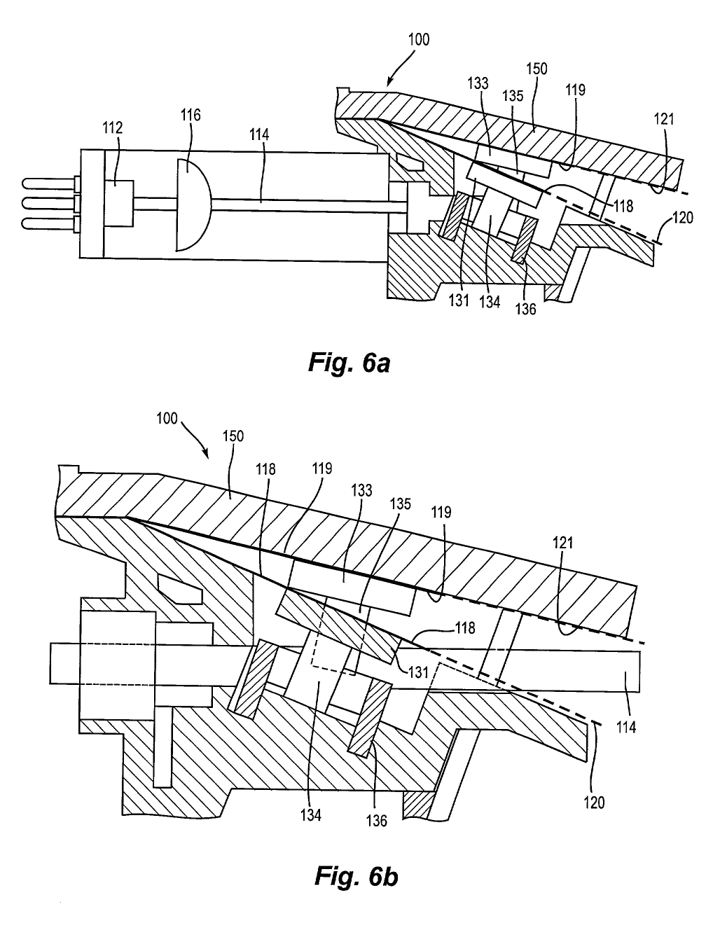

FIGS. 6a and 6b illustrate a side sectional view and a close up side sectional view, respectively, of a scanning assembly 100 utilizing two flex circuits 118, 119. The scanning system 100 is disposed inside a housing 150. One end of each of the flex circuits 118, 119 is fixedly attached to the inside of the housing 150. The flex circuit 118 includes an aperture 120 formed in its free end, and the flex circuit 119 includes an aperture 121 formed in its free end. The apertures 120, 121 are shown as dotted lines in this illustration. The flex circuits 118, 119 have steel keepers 131, 133 soldered to their respective surfaces. Movable magnets 134, 135 are attached to the steel keepers 131, 133. The movable magnets 134, 135 are proximate drive coils 136, 137, respectively. The drive coils 136, 137 are fixed to the inside of the housing 150. Only the drive coil 136 proximate the movable magnet 134 is visible in these figures. Such a moving magnet system may be preferred over a moving coil system because the flex circuits 118, 119 in the moving magnet system do not have conductive traces on their surfaces, thus allowing for thinner more flexible flex circuits.

In FIGS. 6a and 6b, the aperture 121 in flex circuit 119 is positioned out of the outgoing optical path of a light beam 114 generated by a light source 112. The aperture 120 in flex circuit 118, conversely, is positioned in the outgoing optical path of the light beam 114. Thus, only the aperture 120 is used to focus the light beam 114 when the flex circuits 118, 119 are positioned as shown in FIG. 5.

When the drive coil 137 proximate the movable magnet 135 is actuated by an electric current having a polarity that attracts the magnet 135, the magnet 135 moves the aperture 121 into the outgoing optical path of the light beam 114. The aperture 121 is smaller or narrower than the aperture 120 in flex circuit 118. Thus, when the movable magnet 135 is attracted to the drive coil 137, the aperture 121 further focuses the light beam 114. Alternatively, the apertures 120, 121 in both flex circuits 118, 119 may be moved out of the outgoing optical path when their respective drive coils 136, 137 are actuated with currents having polarities that repel the magnets 134, 135. When this actuation occurs, neither aperture 120, 121 contributes to focusing the light beam 114. In such a case, only focusing lens 116 focuses the light beam 114. Accordingly, the final aperture size may be adjusted by moving the apertures 120, 121 into and out of the outgoing optical path. As a result, the focal characteristics of the scanning system 100 may be modified to suit the requirements of a given scanning application.

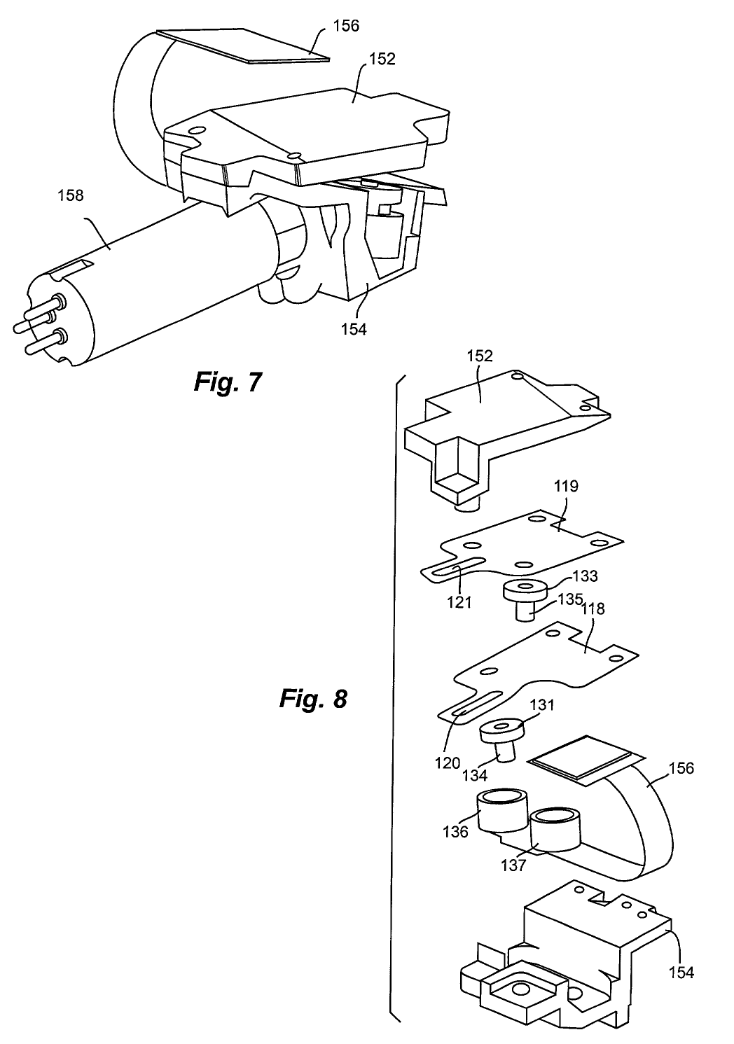

FIGS. 7 and 8 are a perspective view of the dual flex circuit assembly 100 of FIG. 6 and an exploded view of the flex circuit region of the dual flex circuit assembly 100, respectively. The housing 150 is comprised of a top cover 152 and a bottom cover 154. A flex cable 156 is mounted to the inside of the housing 150 and extends outside of the housing 150. The drive coils 136, 137 are mounted on the flex cable 156 inside the housing 150. The light source 112 and the focusing lens 116 are disposed inside a barrel 158, which is fixed to the housing 150.

The flex circuit 119 is located above the flex circuit 118. As a result, the flex circuit 119 may only be positioned in the outgoing optical path of a light beam, or in the “down” position, when the flex circuit 118 is also positioned in the outgoing optical path. Accordingly, the aperture 120 in flex circuit 118 may alone focus a light beam or it may be used in combination with the aperture 121 in flex circuit 119. Alternatively, the apertures 120, 121 in flex circuits 118, 119 may both be positioned out of the outgoing optical path, in which case neither of the apertures 120, 121 contribute to focusing the light beam. In such a case, only the focusing lens focuses the light beam toward the object to be scanned.

Thus the present invention has been set forth in the form of its preferred embodiments. It is nevertheless intended that modifications to the disclosed scanning systems may be made by those skilled in the art without altering the essential inventive concepts set forth herein.

What is claimed is:

1. An optical scanning system, comprising
a light source generating a light beam along an outgoing optical path toward an object to be scanned;
a first flex circuit having a fixed end and a free end with an aperture formed in the free end, the first flex circuit flexing so as to selectively position the aperture in or out of the outgoing optical path.

2. A system according to claim 1 further comprising a housing, wherein the fixed end of the first flex circuit is fixedly attached to the housing.

3. A system according to claim 2 further comprising a magnet attached to the first flex circuit between the fixed end and the free end, and a drive coil attached to the housing proximate the magnet, the drive coil selectively attracting and/or repelling the magnet when the drive coil is actuated by an electric current thereby moving the second end of the first flex circuit into or out of the outgoing optical path.

4. A system according to claim 2 further comprising a coil attached to the first flex circuit between the fixed end and the free end, and a magnet attached to the housing proximate the coil, wherein the magnet is selectively attracted and/or repelled by the coil when the coil is actuated by an electric current thereby moving the second end of the first flex circuit into or out of the outgoing optical path.

5. A system according to claim 1 further comprising second and third flex circuits successively positioned downstream from the first flex circuit, the second and third flex circuits each having an aperture formed therein that is selectively positioned in or out of the outgoing optical path for focusing the light beam.

6. A system according to claim 5 wherein each successive flex circuit in the outgoing optical path includes a smaller aperture than the previous flex circuit in the outgoing optical path.

7. A system according to claim 5 further comprising an electromagnetic mechanism engaging the flex circuits, the electromagnetic mechanism selectively moving at least one of the apertures into or out of the outgoing optical path when the electromagnetic mechanism is actuated.

8. A system according to claim 1 wherein the aperture is circular.

9. A system according to claim 1 wherein the aperture is slot shaped.

10. A system according to claim 1 further comprising a lens positioned in the outgoing optical path, the lens focusing the light beam toward the object.

11. A system according to claim 1 further comprising a scanning assembly positioned in the outgoing optical path, the scanning assembly scanning the light beam toward the object.

12. A system according to claim 11 wherein the scanning assembly comprises a dithering mechanism having a scan mirror that is pivoted over a scan angle.

13. A system according to claim 11 wherein the scanning assembly comprises a rotating polygon mirror.

14. A system according to claim 1 further comprising
an optical collector positioned in an incoming optical path for collecting light reflected off of the object;
a detector positioned in the incoming optical path downstream from the optical collector for detecting light collected by the optical collector.

15. An optical scanning system, comprising
a light source generating a light beam along an outgoing optical path toward an object to be scanned;
a flex circuit having a first fixed end and a second end with an aperture formed therein for focusing the light beam toward the object;
an electromagnetic mechanism engaging the flex circuit, the electromagnetic mechanism selectively moving the second end of the flex circuit into or out of the outgoing optical path.

16. A system according to claim 15 wherein the electromagnetic mechanism comprises a magnet attached to the flex circuit and a fixed drive coil proximate the magnet.

17. A system according to claim 16 wherein the fixed drive coil is adapted to selectively move the second end of the flex circuit into or out of the outgoing optical path when the drive coil is actuated.

18. A system according to claim 15 further comprising a lens positioned in the outgoing optical path for focusing the light beam to a given distance.

19. A system according to claim 15 further comprising
an optical collector positioned in an incoming optical path for collecting light reflected off of the object;
a detector positioned in the incoming optical path downstream from the optical collector for detecting light collected by the optical collector.

20. A method of optical scanning comprising the steps of
generating a light beam along an outgoing optical path;
focusing the light beam with an aperture formed in a first flex circuit;
selectively positioning the aperture in or out of the outgoing optical path by flexing the first flex circuit;
directing the light beam toward a target object.

21. A method of optical scanning according to claim 20 further comprising positioning the aperture in or out of the outgoing optical path via an electromagnetic mechanism.

22. A method of optical scanning according to claim 20 further comprising focusing the light beam with second and third flex circuits each having a smaller aperture than the previous flex circuit in the outgoing optical path.

23. A method of optical scanning according to claim 22 further comprising selectively moving at least one of the apertures into or out of the outgoing optical path via an electromagnetic mechanism when the electromagnetic mechanism is actuated.

24. A method of optical scanning according to claim 20 further comprising focusing the light beam toward the object with a lens positioned in the outgoing optical path.

25. A method of optical scanning according to claim 20 further comprising
collecting return light from the target object with an optical collector;
detecting the collected return light with a detector.
